(19) United States
(12) Patent Application Publication
(10) Pub. No.: US 2014/0120268 A1
(43) Pub. Date: May 1, 2014

(54) METHOD FOR PRODUCING PRESSURE-SENSITIVE ADHESIVE SHEET HAVING ULTRAVIOLET-RAY CURING-TYPE ACRYLIC PRESSURE-SENSITIVE ADHESIVE LAYER

(71) Applicant: NITTO DENKO CORPORATION, OSAKA (JP)

(72) Inventors: Jun Akiyama, Osaka (JP); Tooru Nakashima, Osaka (JP)

(73) Assignee: NITTO DENKO CORPORATION, OSAKA (JP)

(21) Appl. No.: 14/067,213

(22) Filed: Oct. 30, 2013

(30) Foreign Application Priority Data
Oct. 31, 2012 (JP) 2012-240280
Aug. 30, 2013 (JP) 2013-179206

(51) Int. Cl. C09J 5/00

(52) U.S. Cl. CPC C09J 5/00
USPC 427/492

(57) ABSTRACT

Provided is a method for producing an pressure-sensitive adhesive sheet having an ultraviolet-ray curing-type acrylic pressure-sensitive adhesive layer that can undergo, about one or more monomers therefor, high rate-polymerization to be excellent in productivity, and is also excellent in balance between pressure-sensitive adhesive performances. The method includes: a first radiating substep of using, as an ultraviolet source, an LED lamp having a peak wavelength in the range of 300 nm to 450 nm to expose the adhesive composition to light from the LED lamp; and a second radiating substep of using, as an ultraviolet source, an ultraviolet lamp for emitting light having a peak wavelength in the range from 300 nm to 450 nm and further including a wavelength in the range of 100 nm or more and less than 300 nm after the first radiating step to expose the adhesive composition to the light.

### BACKGROUND OF THE INVENTION

1. Field of the Invention

The present invention relates to a method for producing a pressure-sensitive adhesive sheet having an ultraviolet-ray curing-type acrylic pressure-sensitive adhesive layer.

2. Description of the Related Art

Hitherto, an acrylic pressure-sensitive adhesive has been prepared by subjecting monomer components containing an alkyl acrylate as a main component to solution polymerization. A pressure-sensitive adhesive sheet having a pressure-sensitive adhesive layer has been produced by applying a solvent type pressure-sensitive adhesive onto a substrate, and then drying the resultant workpiece.

In recent years, considering air pollution and environmental problems, known has been a method of photopolymerizing the above-specified monomer components through ultraviolet rays to produce a pressure-sensitive adhesive sheet having an acrylic pressure-sensitive adhesive layer. This method is particularly advantageous from the viewpoint of safety and environment since the method makes it possible to produce the pressure-sensitive adhesive sheet without using any solvent.

As the above-mentioned photopolymerization-used method for producing a pressure-sensitive adhesive sheet or a pressure-sensitive adhesive tape (hereinafter referred to as an pressure-sensitive adhesive sheet), U.S. Pat. No. 4,181,752 discloses a method of applying, onto an appropriate substrate, a composition which contains the above-specified monomer components and a photopolymerization initiator as main components (hereinafter, any composition of the same type will be referred to as a composition, or an ultraviolet-ray curing-type acrylic pressure-sensitive adhesive composition), and then radiating, onto this workpiece, ultraviolet rays having wavelengths of 300 to 400 nm at an irradiance of 7 mW/cm² or less to yield a pressure-sensitive adhesive sheet. In this method, the radiation of the ultraviolet rays, which gives the relatively low irradiance, makes a polymer made from the monomer components into a high molecular weight, thereby increasing the cohesive strength of the pressure-sensitive adhesive layer (of the sheet). In such a way, a pressure-sensitive adhesive sheet can be obtained which is high in holding power at high temperature. Although the pressure-sensitive adhesive sheet yielded by this method has an advantage that its pressure-sensitive adhesive layer is improved in cohesive strength, the sheet has a problem of being low in adhering strength onto a rough surface because of a narrow molecular weight of molecules in the layer. Additionally, in the method, under conditions of radiating the ultraviolet rays at the low irradiance, the polymerization rate becomes small so that the method causes a problem of productivity. By contrast, under conditions of radiating the ultraviolet rays at a high irradiance, the polymerization rate is improved; however, radicals are rapidly consumed. As a result, a polymer made from the monomer components is lowered in molecular weight so that the pressure-sensitive adhesive sheet cannot be made high in holding power at high temperature.

Against these problems, JP-B-7-53849 and JP-A-7-331198 each disclose a method of radiating ultraviolet rays initially onto the above-specified monomer components at a low irradiance to cause at least 80% of the quantity of the monomer components, and then radiating ultraviolet rays onto the workpiece at a higher irradiance than the initial irradiance, whereby the method is improved in productivity while the resultant pressure-sensitive adhesive layer keeps a high cohesive strength. However, this method cannot solve the problem that this pressure-sensitive adhesive layer is low in adhering strength onto a rough surface. The method also causes the following problem: ultraviolet rays are radiated at a low irradiance until most of the polymerization reaction is finished; thus, the method requires a longer polymerization reaction period than the method of radiating ultraviolet rays at a high irradiance, so as to be poorer in productivity.

### PRIOR ART DOCUMENTS

### Patent Documents

Patent Document 1: U.S. Pat. No. 4,181,752
Patent Document 2: JP-B-7-53849
Patent Document 3: JP-A-7-331198

### SUMMARY OF THE INVENTION

The present invention has been made to solve the problems, and an object thereof is to provide a method for producing an pressure-sensitive adhesive sheet having an ultraviolet-ray curing-type acrylic pressure-sensitive adhesive layer that can undergo, about one or more monomers therefor, high-rate-polymerization to be excellent in productivity, and is also excellent in balance between pressure-sensitive adhesive performances, such as holding power at high temperature.

In order to solve the problems, the inventors have made eager investigations to find out that the object can be attained by a method described below for producing a pressure-sensitive adhesive sheet having an ultraviolet-ray curing-type acrylic pressure-sensitive adhesive layer.

The present invention relates to a method for producing a pressure-sensitive adhesive sheet, the method comprising: an applying step in which an ultraviolet-ray curing-type acrylic pressure-sensitive adhesive composition containing at least a monomer-component matter that is/contains an alkyl (meth)acrylate, and/or a partial polymer made from the monomer-component matter, and a photopolymerization initiator, is applied onto a substrate; an pressure-sensitive adhesive layer forming step in which the pressure-sensitive adhesive composition is irradiated with and cured by ultraviolet light to form a pressure-sensitive adhesive layer; wherein the pressure-sensitive adhesive layer forming step has a first radiating substep of using, as an ultraviolet source, an LED lamp having a peak wavelength in the range of 300 nm to 450 nm to expose the pressure-sensitive adhesive composition to light from the LED lamp; and a second radiating substep of using, as an ultraviolet source, an ultraviolet lamp for emitting light having a peak wavelength in the range from 300 nm to 450 nm and further including a wavelength in the range of 100 nm or more and less than 300 nm after the first radiating substep to expose the pressure-sensitive adhesive composition to the light; and wherein, at a time when the first radiating substep has ended, a polymerization rate of the pressure-sensitive adhesive composition is 50% or more.

An irradiance of the ultraviolet rays in each of the first and second radiating substeps is 20 mW/cm² or more.

The photopolymerization initiator contains at least a first photopolymerization initiator species having an absorption coefficient of 1×10² mLg⁻¹ cm⁻¹ or more at 405 nm, and an absorption coefficient of 1×10² mLg⁻¹ cm⁻¹ or more at 302 nm, and a second photopolymerization initiator species having an absorption coefficient of less than 1×10² mLg⁻¹ cm⁻¹ at 405 nm, and an absorption coefficient of 1×10² mLg⁻¹ cm⁻¹ or more at 302 nm; wherein content of the first photopolymerization initiator species in the pressure-sensitive adhesive composition is from 0.01 parts by weight to 5 parts by weight for 100 parts by weight of the monomer-component matter, which is/contains the alkyl (meth)acrylate, and/or the partial polymer made from the monomer-component matter; and wherein content of the second photopolymerization initiator species in the pressure-sensitive adhesive composition is from 0.01 parts by weight to 5 parts by weight for 100 parts by weight of the monomer-component matter, which is/contains the alkyl (meth)acrylate, and/or the partial polymer made from the monomer-component matter.

The monomer-component matter comprises a polyfunctional monomer.

### Effects of the Invention

According to the invention, it is possible to provide a pressure-sensitive adhesive sheet having an ultraviolet-ray curing-type acrylic pressure-sensitive adhesive layer which can undergo, about one or more monomers therefor, high-rate-polymerization to be excellent in productivity, and is also excellent in balance between pressure-sensitive adhesive performances, such as holding power at high temperature.

### DETAILED DESCRIPTION OF THE PREFERRED EMBODIMENTS

Hereinafter, a description will be made about a method according to an embodiment of the invention for producing a pressure-sensitive adhesive sheet having an ultraviolet-ray curing-type acrylic pressure-sensitive adhesive layer.

An ultraviolet-ray curing-type acrylic pressure-sensitive adhesive composition used in the present embodiment is a composition comprising a photopolymerization initiator, and a monomer-component matter that is/comprises an alkyl (meth)acrylate and/or a partial polymer made from the monomer-component matter. The composition is a composition which is applied onto a substrate, and then irradiated with ultraviolet rays, thereby undergoing the polymerization of the monomer-component matter therein, so as to be turned to an ultraviolet-ray curing-type acrylic pressure-sensitive adhesive layer.

The alkyl (meth)acrylate used in the embodiment may be, for example, an alkyl (meth)acrylate having a linear or branched alkyl group having about 1 to 20 carbon atoms, preferably an alkyl (meth)acrylate having a linear or branched alkyl group having about 2 to 14 carbon atoms. Specific examples thereof include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl(meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. In the present specification, the wordings “(meth)acrylate” and “(meth)acrylic” mean “acrylate and/or methacrylate” and “acrylic and/or methacrylic”, respectively.

The alkyl (meth)acrylate other than the above-mentioned alkyl (meth)acrylate, which has a linear or branched alkyl group, is preferably, for example, an alkyl (meth)acrylate having an alicyclic hydrocarbon group, such as cyclopentyl (meth)acrylate, a cycloalkyl (meth)acrylate or isobornyl (meth)acrylate.

The monomer-component matter used in the embodiment may be made of a single alkyl (meth)acrylate, or a mixture of plural alkyl (meth)acrylates. The monomer-component matter may also be a mixture of an alkyl (meth)acrylate and any other copolymerizable monomer. Further, a partial polymer made from the monomer-component matter may be used in the embodiment.

In the embodiment, the alkyl (meth)acrylate(s) is/are (each) used as the whole or a main component of the monomer-component matter, which is to constitute the ultraviolet-ray curing-type acrylic pressure-sensitive adhesive layer, Thus, the content by percentage thereof is 60% or more by weight, preferably 80% or more by weight of the whole of the monomer-component matter, which is to constitute the pressure-sensitive adhesive layer.

In order that the ultraviolet-ray curing-type acrylic pressure-sensitive adhesive layer used in the invention can be improved in adhering strength onto an adherend, cohesive strength, heat-resistance, and other properties, this pressure-sensitive adhesive layer may contain, besides the alkyl (meth)acrylate(s), a polar-group-containing monomer copolymerizable therewith as one component of the monomer-component matter, which is to constitute the pressure-sensitive adhesive layer.

Examples of the polar-group-containing monomer include carboxyl-group-containing monomers, such as (meth)acrylic acid, carboxyethyl (meth)acrylate, carboxypentyl (meth)acrylate, itaconic acid, maleic acid, fumaric acid, crotonic acid, and isocrotonic acid; acid anhydride monomers such as maleic anhydride, and itaconic anhydride; hydroxyl-group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)methyl (meth)acrylate; sulfonate-group-containing monomers such as styrenesulfonic acid, allylsulfonic acid, 2-(meth)acrylamide-2-methylpropanesulfonic acid, (meth)acrylamidepropanesulfonic acid, sulfopropyl (meth)acrylate, and (meth)acryloyloxynaphthalenesulfonic acid; phosphate-group-containing monomers such as 2-hydroxyethylacryloyl phosphate; amide-group-containing monomers such as acrylamide, methacrylamide, N,N-dimethyl(meth)acrylamide, N-methylol(meth)acrylamide, N-methoxymethyl(meth)acrylamide, and N-butoxymethyl(meth)acrylamide; amino-group-containing monomers such as aminoethyl (meth)acrylate, dimethylaminoethyl (meth)acrylate, and t-butylaminoethyl (meth)acrylate; glycidyl-group-containing monomers such as glycidyl (meth)acrylate, and methylglycidyl (meth)acrylate; cyano-group-containing monomers such as acrylonitrile, and methacrylonitrile; and heterocyclic-ring-containing vinyl monomers such as N-vinylpyridine, N-vinylpiperidone, N-vinylpyrimidine, N-vinylpiperazine, N-vinylpyrrole, N-vinylimidazole, and N-vinyloxazole. These copolymerizable monomers may be used alone or in combination of two or more thereof.

The content by percentage of the polar-group-monomer is 30% or less by weight of the whole of the monomer-component matter, preferably from 3% by weight thereof to 20% by weight thereof. If the content by percentage is more than 30% by weight, for example, the pressure-sensitive adhesive layer may become too high in cohesive strength to be unfavorably declined in adhesive strength.

For the adjustment of the cohesive strength of the pressure-sensitive adhesive layer, the pressure-sensitive adhesive layer may contain a polyfunctional monomer which is a bifunctional or higher functional monomer, as one component of the monomer-component matter, which is to constitute the ultraviolet-ray curing-type acrylic pressure-sensitive adhesive layer, besides the above-mentioned components.

Examples of the polyfunctional monomer include trimethylolpropane tri(meth)acrylate, pentaerythritol di(meth)acrylate, pentaerythritol tri(meth)acrylate, pentaerythritol tetra(meth)acrylate, dipentaerythritol hexa(meth)acrylate, 1,2-ethylene glycol di(meth)acrylate, 1,6-hexanediol (meth)acrylate, 1,12-dodecanediol di(meth)acrylate, (poly)ethylene glycol di(meth)acrylate, (poly)propylene glycol di(meth)acrylate, neopentyl glycol di(meth)acrylate, tetramethylolmethane tri(meth)acrylate, allyl (meth)acrylate, vinyl (meth)acrylate, divinylbenzene, epoxy acrylate, polyester acrylate, and urethane acrylate.

The content by percentage of the polyfunctional monomer is 2% or less by weight of the whole of the monomer-component matter, preferably from 0.02% by weight thereof to 1% by weight thereof. If the content by percentage is more than 2% by weight, for example, the pressure-sensitive adhesive layer becomes too high in cohesive strength to be possibly declined in adhesive strength.

Examples of the copolymerizable monomer (as one component of the monomer-component matter) other than the polar-group-containing monomer and the polyfunctional monomer include vinyl esters such as vinyl acetate, and vinyl propionate; aromatic vinyl compounds such as vinylbenzene, and vinyltoluene; olefins or dienes such as ethylene, butadiene, isoprene, and isobutylene; vinyl ethers such as vinyl alkyl ethers; vinyl chloride; alkoxyalkyl (meth)acrylate monomers such as methoxyethyl (meth)acrylate, and ethoxyethyl (meth)acrylate; imide-group-containing monomers such as cyclohexylmaleimide, and isopropylmaleimide; isocyanate-group-containing monomers such as 2-methacryloyloxyethylisocyanate; fluorine-atom-containing (meth)acrylates; and silicon-atom-containing (meth)acrylates. The content by percentage of the copolymerizable monomer is preferably from 0.1% by weight to 40% by weight, more preferably from 0.5% by weight to 30% by weight of the whole of the monomer-component matter. If the content by percentage of the copolymerizable monomer is more than 40% by weight, possibly declined in tackiness, in particular, at normal temperature. If the content by percentage of the copolymerizable monomer is less than 0.1% by weight, the pressure-sensitive adhesive layer is declined in cohesive strength not to gain a high shear adhering strength.

The ultraviolet-ray curing-type acrylic adhesive composition contains a photopolymerization initiator. The photopolymerization initiator is not particularly limited as far as the initiator is a substance which can generate radicals by irradiation with ultraviolet rays to initiate photopolymerization. Any one of ordinarily used photopolymerization initiators can be preferably used, examples thereof including benzoin ether based, acetophenone based, α-ketol based, optically active oxime based, benzoin based, benzil based, benzophenone based, ketal based, thioxanthone based, and acylphosphine oxide based photopolymerization initiators.

Specific examples of the benzoin ether based photopolymerization initiators include benzoin methyl ether, benzoin ethyl ether, benzoin propyl ether, benzoin isopropyl ether, benzoin isobutyl ether, 2,2-dimethoxy-1,2-diphenylethane-1-one, and anisole methyl ether.

Examples of the acetophenone based photopolymerization initiators include 2,2-diethoxyacetophenone, 2,2-dimethoxy-2-phenylacetophenone, 1-hydroxycyclohexyl phenyl ketone, 4-phenoxydichloroacetophenone, and 4-t-butyldichloroacetophenone.

Examples of the α-ketol based photopolymerization initiators include 2-methyl-2-hydroxypropiophenone, and 1-[4-(2-hydroxyethyl)phenyl]-2-hydroxy-2-methylpropane-1-one.

Examples of the optically active oxime based photopolymerization initiators include 1-phenyl-1,1-propanedione-2-(o-ethoxycarbonyl)-oxime.

Examples of the benzoin based photopolymerization initiators include benzoin.

Examples of the benzil based photopolymerization initiators include benzil.

Examples of the benzophenone based photopolymerization initiators include benzophenone, benzoylbenzoic acid, 3,3′-dimethyl-4-methoxybenzophenone, polyvinylbenzophenone, and α-hydroxycyclohexyl phenyl ketone.

Examples of the ketal based photopolymerization initiators include benzyl dimethyl ketal.

Examples of the thioxanthone based photopolymerization initiators include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone.

Examples of the acylphosphine oxide based photopolymerization initiator include 2,4,6-trimethylbenzoyl-diphenyl-phosphine oxide, and bis(2,4,6-trimethylbenzoyl)-phenylphosphine oxide.

The content of the photopolymerization initiator is not particularly limited. The content is from 0.02 to 10 parts by weight, preferably from 0.06 to 6 parts by weight for 100 parts by weight of the monomer-component matter, which is/contains an alkyl (meth)acrylate, and/or the partial polymer made from the monomer-component matter. If the content of the photopolymerization initiator is less than 0.02 parts by weight, the photopolymerization reaction may become insufficient. If the content of the photopolymerization initiator is more than 6 parts by weight, the resultant polymer may be lowered in molecular weight so that the pressure-sensitive adhesive layer may be deteriorated in cohesive strength.

Species of the afore-mentioned photopolymerization initiator are usable alone or in any combination of two or more thereof. It is preferred to use at least a first photopolymerization initiator species having an absorption coefficient of 1×10² mLg⁻¹ cm⁻¹ or more at 405 nm, and an absorption coefficient of 1×10² mLg⁻¹ cm⁻¹ or more at 302 nm, and a second photopolymerization initiator species having an absorption coefficient of less than 1×10² mLg⁻¹ cm⁻¹ at 405 nm, and an absorption coefficient of 1×10² mLg⁻¹ cm⁻¹ or more at 302 nm.

In the present embodiment, the use of the two photopolymerization initiator species different from each other in absorption property makes it possible to cleave the first photopolymerization initiator species in the first radiating substep and cleave the first and second photopolymerization initiator species in the second radiating substep. Thus, at the late period of the polymerization also, sufficient radicals can be supplied by the radiation of ultraviolet rays, so that a high-polymerization-rate pressure-sensitive adhesive sheet can be produced.

Examples of the first photopolymerization initiator species include acylphosphine oxides such as 2,4,6-trimethylbenzoyldiphenylphosphine oxide (trade name: Lucirin TPO, manufactured by BASF Corp.), 2,4,6-trimethylbenzoylphenylethoxyphosphine oxide (trade name: Lucirin TPO-L, manufactured by BASF Corp.); aminoketones such as 2-benzyl-2-dimethylamino-1-(4-morpholinophenyl)butanone-1 (trade name: Irgacure 369, manufactured by BASF Corp.); and bisacylphosphine oxides such as bis(2,4,6-trimethylbenzoyl)-phenylphosphine oxide (trade name: Irgacure 819, manufactured by BASF Corp.), 2,2-dimethoxy-1,2-diphenylethane-1-one (trade name: Irgacure 651, manufactured by BASF Corp.), and bis(2,6-dimethoxybenzoyl)-2,4,4-trimethylpentylphosphine oxide (trade name: CGI 403, manufactured by BASF Corp.).

The content of the first photopolymerization initiator species is not particularly limited, and is usually from 0.01 parts by weight to 5 parts by weight, preferably from 0.03 parts by weight to 3 parts by weight for 100 parts by weight of the monomer-component matter, which is/contains an alkyl (meth)acrylate, and/or the partial polymer made from the monomer-component matter. If the content of the first photopolymerization initiator species is less than 0.01 parts by weight, the ultraviolet-ray curing-type acrylic pressure-sensitive adhesive composition does not become sufficiently large in polymerization rate in the first radiating substep so that the photopolymerization reaction may become insufficient. If the content of the first photopolymerization initiator species is more than 5 parts by weight, the resultant polymer may be lowered in molecular weight so that the pressure-sensitive adhesive layer may be deteriorated in cohesive strength.

Examples of the second photopolymerization initiator species include hydroxyketones such as hydroxycyclohexyl phenyl ketone (trade name: Irgacure 184, manufactured by BASF Corp.), hydroxy-2-methyl-1-phenyl-propane-1-one (trade name: Darocure 1173, manufactured by BASF Corp.), and 2-hydroxyl-{4-[4-(2-hydroxy-2-methyl-propionyl)-benzyl]phen yl}-2-methyl-propane-1-one (trade name: Irgacure 127, manufactured by BASF Corp.); benzophenones such as benzophenone, 2,4,6-trimethylbenzophenone, and 4-methylbenzophenone; benzyl methyl ketal (trade name: Esacure KB 1, manufactured by Nihon Siber Hegner K.K.); and 2-hydroxy-2-methyl-[4-(1-methylvinyl)phenyl]propanol oligomer (trade name: Esacure KIP 150, manufactured by Nihon Siber Hegner K.K.).

The content of the second photopolymerization initiator species is not particularly limited, and is usually from 0.01 parts by weight to 5 parts by weight, preferably from 0.03 parts by weight to 3 parts by weight for 100 parts by weight of the monomer-component matter, which is/contains an alkyl (meth)acrylate, and/or the partial polymer made from the monomer-component matter. If the content of the second photopolymerization initiator species is less than 0.01 parts by weight, the ultraviolet-ray curing-type acrylic pressure-sensitive adhesive composition may become sufficiently large in polymerization rate in the second radiating substep to cause an unreacted fragment of the monomer(s) to remain so that a high-polymerization-rate pressure-sensitive adhesive sheet may be unable to be produced. If the content of the second photopolymerization initiator species is more than 5 parts by weight, the monomer-component matter may be cleaved in the first radiating substep also. Thus, the resultant polymer may be lowered in molecular weight so that the pressure-sensitive adhesive layer may be deteriorated in cohesive strength.

In the embodiment, an appropriate additive, besides the monomer-component matter and the photopolymerization initiator, may be incorporated into the ultraviolet-ray curing-type acrylic adhesive composition in accordance with the use purpose thereof. Examples of the additive include crosslinking agents (such as polyisocyanate based, silicone based, epoxy based, and alkyl-etherized melamine based crosslinking agents); tackifiers (such as rosin derivative resin, polyterpene resin, petroleum resin, oil-soluble phenolic resin, and other tackifiers in a solid, semisolid or liquid form at normal temperature); fillers such as hollow glass balloons; plasticizers; anti-aging agents; and antioxidants. A colorant, such as a pigment or dye, may be incorporated thereinto as far as the colorant does not hinder the photopolymerization.

In the embodiment, it is preferred to adjust the ultraviolet-ray curing-type acrylic pressure-sensitive adhesive composition into a viscosity appropriate for the work of applying the composition onto a substrate, or a work similar thereto. The adjustment of the viscosity of this composition is attained, for example, by adding a polymer, a polyfunctional monomer or an analogue that may be of various types, such as a polymeric thickening additive, or by subjecting the monomer-component matter in the ultraviolet-ray curing-type acrylic adhesive composition to partial polymerization. The partial polymerization may be conducted before or after the addition of the polymer, the polyfunctional monomer or the analogue that may be of various types, such as a polymeric thickening additive. The viscosity of the ultraviolet-ray curing-type acrylic pressure-sensitive adhesive composition may also be varied in accordance with the amount of the additive, or other factors. When the monomer-component matter in the ultraviolet-ray curing-type acrylic adhesive composition is partially polymerized, the polymerization rate to be attained cannot be decided without reservation. For reference, the polymerization rate is preferably 20% or less, more preferably 15% or less. If the rate is more than 20%, the polymer becomes too high in viscosity so that the composition is not easily applied onto a substrate.

In the embodiment, the ultraviolet-ray curing-type acrylic pressure-sensitive adhesive composition is applied onto a substrate for a pressure-sensitive adhesive sheet.

The substrate used in the embodiment, for a pressure-sensitive adhesive sheet, may be a substrate that may be of various materials, for example, a synthetic resin film such as a polyester film, or a fibrous substrate.

The method for applying the ultraviolet-ray curing-type acrylic pressure-sensitive adhesive composition onto the substrate is not particularly limited, and may be a known appropriate method such as roll coating, bar coating or die coating.

In the embodiment, the ultraviolet-ray curing-type acrylic pressure-sensitive adhesive composition is applied onto a surface or both surfaces of the substrate, and then ultraviolet rays are radiated to this ultraviolet-ray curing-type acrylic pressure-sensitive adhesive composition to photopolymerize the monomer-component matter in the ultraviolet-ray curing-type acrylic pressure-sensitive adhesive composition to form an ultraviolet-ray curing-type acrylic pressure-sensitive adhesive layer. In this way, a pressure-sensitive adhesive sheet is produced.

In the present embodiment, the radiation of ultraviolet rays to the ultraviolet-ray curing-type acrylic pressure-sensitive adhesive composition is attained by using, as an ultraviolet source, an LED lamp having a peak wavelength in the range of 300 nm to 450 nm to expose the pressure-sensitive adhesive composition to light from the LED lamp, and subsequently using, as an ultraviolet source, an ultraviolet lamp for emitting light having a peak wavelength in the range from 300 nm to 450 nm and further including a wavelength in the range of 100 nm or more and less than 300 nm to expose the adhesive composition to the light. The step for the exposure using the former ultraviolet source is the first radiating substep. The step for the exposure using the latter ultraviolet source is the second radiating substep.

### [First Radiating Substep]

In the present embodiment, as the ultraviolet source in the first radiating substep, an LED lamp is used which has a peak wavelength in the range of 300 to 450 nm. The LED lamp is lower in emission heat than other ultraviolet lamps to make it possible to restrain a rise in the temperature of the pressure-sensitive adhesive layer at the early period the polymerization. This matter makes it possible to prevent the polymer from being lowered in molecular weight to prevent the adhesive layer from being deteriorated in cohesive strength and heighten the adhesive sheet in holding power at high temperature. If the peak wavelength of the ultraviolet rays radiated in the first radiating substep is more than 450 nm, the photopolymerization initiator is not decomposed so that the polymerization reaction may not be initiated. If the peak wavelength of the ultraviolet rays is less than 300 nm, the polymer chains are cleaved so that the adhesive layer may be deteriorated in adhesive property. If the light radiated in the first radiating substep contains a wavelength less than 300 nm, the polymer chains are cleaved in the same manner as when the peak wavelength of the ultraviolet rays is less than 300 nm, so that the adhesive layer may be deteriorated in adhesive property. It is therefore preferred that the light radiated in the first radiating substep does not contain any wavelength less than 300 nm.

The irradiance of the ultraviolet rays radiated in the first radiating substep is preferably 20 mW/cm² or more, more preferably 30 mW/cm² or more. If the irradiance of the ultraviolet rays is less than 30 mW/cm², the polymerization reaction period becomes long so that the pressure-sensitive adhesive sheet may be poor in productivity. The irradiance of the ultraviolet rays is preferably 300 mW/cm² or less. If the irradiance of the ultraviolet rays is more than 300 mW/cm², the photopolymerization initiator is abruptly consumed so that the polymer is lowered in molecular weight. Thus, the holding power may be deteriorated, in particular, at high temperature. In the present specification, the irradiance of ultraviolet rays is measured, using a measuring instrument, “UV Power Pack (trade name)”, manufactured by EIT Inc.

In the first radiating substep, the ultraviolet rays may be continuously radiated, or intermittently radiated to produce bright periods when the ultraviolet rays are radiated, and dark periods when not radiated.

In the present embodiment, about the photopolymerization reaction of the monomer-component matter in the ultraviolet-ray curing-type acrylic pressure-sensitive adhesive composition, the polymerization rate of the monomer-component matter is preferably 50% or more, more preferably 70% or more when the radiation of the ultraviolet rays is ended in the first radiating substep. If the polymerization rate of the monomer-component matter is less than 50%, the advantage of the LED lamp, i.e., the prevention of a decrease in the molecular weight of the polymer, cannot be attained so that the pressure-sensitive adhesive layer may be deteriorated in cohesive strength and further the holding power is deteriorated, in particular, at high temperature. In the present embodiment, about the polymerization reaction of the monomer-component matter in the adhesive composition, the polymerization rate of the monomer-component matter is preferably 95% or less, more preferably 90% or less when the radiation of the ultraviolet rays is ended in the first radiating substep. When the ultraviolet rays are radiated in the first radiating substep until the polymerization rate of the monomer-component matter exceeds 95%, much time is required so that the pressure-sensitive adhesive sheet is poor in productivity. In the specification, the polymerization rate of any monomer-component matter is measured by a method that will be described in Examples.

### [Second Radiating Substep]

In the present embodiment, as the ultraviolet source in the second radiating substep, an ultraviolet lamp is used which is for emitting light having a peak wavelength in the range from 300 nm to 450 nm and further including a wavelength in the range of 100 nm or more and less than 300 nm. Examples of the ultraviolet source include a low-pressure mercury lamp, a high-pressure mercury lamp, an ultrahigh-pressure mercury lamp, a metal halide lamp, a non-electrode lamp, a xenon lamp, a deep UV lamp, and an excimer lamp.

As described above, in the embodiment, an LED lamp is used which has a peak wavelength in the range of 300 nm to 450 nm in the first radiating substep, and this matter makes it possible to prevent the polymer from being lowered in molecular weight to prevent the pressure-sensitive adhesive layer from being deteriorated in cohesive strength and heighten the pressure-sensitive adhesive sheet in holding power at high temperature. However, when the ultraviolet rays are continuously radiated under the radiating conditions in the first radiating substep, the polymerization velocity is slow since the temperature for the polymerization is low. Thus, the adhesive sheet may be poor in productivity. Thus, by using the ultraviolet source in the second radiating substep to radiate ultraviolet rays, an ultraviolet-ray curing-type acrylic pressure-sensitive adhesive composition having a high polymerization rate can be obtained in a shorter period than by using a single light source. In other words, the embodiment is caused to have the first and second radiating substeps, thereby shortening the total ultraviolet-ray-radiating period necessary for giving an ultraviolet-ray curing-type acrylic pressure-sensitive adhesive having a desired polymerization rate. If the peak wavelength of the ultraviolet rays radiated in the second radiating substep is more than 450 nm, the photopolymerization initiator is not decomposed so that the polymerization reaction may not be initiated. If the peak wavelength of the ultraviolet rays is less than 300 nm, the polymer chains may be cleaved so that the adhesive layer may be deteriorated in adhesive property. The light radiated in the second radiating substep contains a feeble wavelength in the range of 100 nm or more and less than 300 nm, thus making it possible to cleave sufficiently a fragment of the photopolymerization initiator that remains in the adhesive composition at the late period of the polymerization without cutting the polymer chains. Thus, a pressure-sensitive adhesive sheet can be obtained which is high in polymerization rate and gives little odor.

The irradiance of the ultraviolet rays radiated in the second radiating substep is preferably 20 mW/cm² or more, more preferably 30 mW/cm² or more. If the irradiance of the ultraviolet rays is less than 30 mW/cm², the polymerization reaction period becomes long so that the pressure-sensitive adhesive sheet may be poor in productivity. The irradiance of the ultraviolet rays is preferably 1000 mW/cm² or less. If the irradiance of the ultraviolet rays is more than 1000 mW/cm², the photopolymerization initiator is abruptly consumed so that the polymer may be lowered in molecular weight. Thus, particularly at high temperature, the adhesive sheet may be deteriorated in holding power.

In the second radiating substep, the ultraviolet rays may be continuously radiated, or intermittently radiated to produce bright periods when the ultraviolet rays are radiated, and dark periods when not radiated.

About the monomer-component matter in the ultraviolet-ray curing-type acrylic pressure-sensitive adhesive composition, the final polymerization rate is preferably 95% or more, more preferably 97% or more. If the polymerization rate is less than 95%, the pressure-sensitive adhesive sheet may be deteriorated in properties. Considering the productivity thereof, the period when this final polymerization rate becomes 95% or more is preferably 80 seconds or less, more preferably 60 seconds or less.

In the present embodiment, a preliminary radiating substep may be performed before the first radiating substep. In this case, at the moment when the workpiece is shifted from the preliminary radiating substep to the first radiating substep, the polymerization rate of the monomer-component matter is preferably 30% or less, more preferably 20% or less, in particular preferably 10% or less. Performing the preliminary radiating step makes it possible to shorten an induction period at the initial stage of the polymerization so that a pressure-sensitive adhesive sheet can be effectively produced. However, if the polymerization rate of the monomer-component matter is 30% or more, the polymer cannot be prevented from being lowered in molecular weight so that the pressure-sensitive adhesive layer may be deteriorated in cohesive strength and the holding power may be lowering, particularly, at high temperature.

An ultraviolet source in the preliminary radiating substep may be an ultraviolet lamp for emitting light having a peak wavelength in the range of 200 nm to 500 nm. Examples of this ultraviolet source include a low-pressure mercury lamp, a high-pressure mercury lamp, an ultrahigh-pressure mercury lamp, a metal halide lamp, a non-electrode lamp, a xenon lamp, a deep UV lamp, an excimer lamp, and an LED lamp.

The reaction is hindered by oxygen in the air. Thus, in order to block oxygen, it is preferred to form a release film or an analogue thereof onto a layer based on the application of the acrylic adhesive composition, or conduct the photopolymerization reaction in the atmosphere of nitrogen. A release treatment agent (release agent) used when a release film or an analogue thereof is formed onto a substrate on which the application-based layer is to be formed may be, for example, a silicone release agent, or a long-chain-alkyl containing release agent.

The pressure-sensitive adhesive sheet of the embodiment may be produced by using a release paper piece as the substrate, forming an ultraviolet-ray curing-type acrylic pressure-sensitive adhesive layer onto the release paper piece, and then transferring this ultraviolet-ray curing-type acrylic pressure-sensitive adhesive layer onto another substrate.

The thickness of the pressure-sensitive adhesive sheet produced in the production method of the present embodiment is not particularly limited, and is preferably adjusted to set the thickness of its pressure-sensitive adhesive layer into the range of 0.01 mm to 10 mm, particularly, 0.02 mm to 5 mm. If the thickness of the adhesive layer is more than 10 mm, ultraviolet rays do not easily transmit the layer so that it takes much time to polymerize the monomer-component matter. Thus, the adhesive sheet may be poor in productivity.

### EXAMPLES

Hereinafter, the invention will be described in detail by way of examples; however, the invention is never limited by these examples.

### Preparation of Acrylic Polymer Syrup 1:

Into a three-necked flask were charged 90 parts by weight of 2-ethylhexyl acrylate (2EHA), 10 parts by weight of acrylic acid, and 0.05 parts by weight of a photopolymerization initiator “Irgacure 819”. The mixture was exposed to ultraviolet rays in the atmosphere of nitrogen to photopolymerize the monomer-component matter therein partially, thus yielding a partial polymer (acrylic polymer syrup 1) having a polymerization rate of 10%.

### Preparation of Acrylic Polymer Syrup 2:

A photopolymerization was performed in the same way as used for the acrylic polymer syrup 1 except that the photopolymerization initiator for the acrylic polymer syrup 1 was changed to 0.05 parts by weight of an initiator “Irgacure 184”, and 0.05 parts by weight of an initiator “Irgacure 651”, thus yielding a partial polymer (acrylic polymer syrup 2) having a polymerization rate of 8%.

### Preparation of Acrylic-Polymer Syrup 3:

A photopolymerization was performed in the same way as used for the acrylic-polymer syrup 1 except that the photopolymerization initiator for the acrylic polymer syrup 1 was changed to 0.1 parts by weight of an initiator “Irgacure 651”, thus yielding a partial polymer (acrylic polymer syrup 3) having a polymerization rate of 8%.

### Preparation of Acrylic Polymer Syrup 4:

A photopolymerization was performed in the same way as used for the acrylic polymer syrup 1 except that the photopolymerization initiator for the acrylic polymer syrup 1 was changed to 0.1 parts by weight of an initiator “Irgacure 184”, thus yielding a partial polymer (acrylic polymer syrup 4) having a polymerization rate of 8%.

### Example 1

### Preparation of Ultraviolet-Ray Curing-Type Acrylic Pressure-Sensitive Adhesive Composition

To 100 parts by weight of the acrylic polymer syrup 1 were added 0.05 parts by weight of a photopolymerization initiator “Irgacure 184” and 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

Prepared was a polyester film (trade name: MRF, manufactured by Mitsubishi Polyester Film Inc.) having a surface releasing-agent-treated with silicone and having a thickness of 38 μm. An applicator was used to paint the ultraviolet-ray curing-type acrylic pressure-sensitive adhesive composition onto the releasing-agent-treated surface to give a final thickness of 60 μm, thus forming a painted layer. Next, the surface of the painted adhesive composition was coated with the same 38-μm-thickness polyester film (trade name: MRN, manufactured by Mitsubishi Polyester Film Inc.) to locate the releasing-agent-treated surface of this film at the painted-surface side of the workpiece. In this way, the painted layer of the adhesive composition was blocked from oxygen. The thus-obtained adhesive sheet was irradiated with ultraviolet rays having an irradiance of 75 mW/cm² at wavelengths of 320 nm to 450 nm from an LED lamp (manufactured by Hamamatsu Photonics K.K.) having a peak wavelength of 365 nm for 30 seconds in a first radiating substep. In this way, an adhesive sheet having a polymerization rate of 87% was yielded. Next, this sheet was irradiated with ultraviolet rays having an irradiance of 75 mW/cm² at wavelengths of 320 nm to 450 nm from a metal halide lamp (manufactured by Harison Toshiba Lighting Corp.) having a peak wavelength of 365 nm for 20 seconds in a second radiating substep while transported. Thus, the total of the ultraviolet ray radiating periods in the first and second radiating substeps was 50 seconds. As a result, a pressure-sensitive adhesive sheet having a polymerization rate of 99% was yielded.

### Example 2

### Preparation of Ultraviolet-Ray Curing-Type Acrylic Pressure-Sensitive Adhesive Composition

To 100 parts by weight of the acrylic polymer syrup 1 were added 0.5 parts by weight of a photopolymerization initiator “Irgacure 184” and 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 99% was produced in the same way as in Example 1 except that: the adhesive composition described just above was used; and the ultraviolet lamp in the first radiating substep was changed to an LED lamp (manufactured by Hamamatsu Photonics K.K.) having a peak wavelength of 385 nm, and ultraviolet rays having an irradiance of 40 mW/cm² at wavelengths of 320 nm to 450 nm were radiated therefrom for 30 seconds to yield an adhesive sheet having a polymerization rate of 81% (the total of the ultraviolet ray radiating periods in the first and second radiating substeps was unchanged to be 50 seconds).

### Example 3

### Preparation of Ultraviolet-Ray Curing-Type Acrylic Pressure-Sensitive Adhesive Composition

To 100 parts by weight of the acrylic polymer syrup 1 were added 0.5 parts by weight of a photopolymerization initiator “Irgacure 127” and 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 99% was produced in the same way as in Example 1 except that: the adhesive composition described just above was used; and from the ultraviolet lamp in the first radiating substep, which was an LED lamp (manufactured by Hamamatsu Photonics K.K.) having a peak wavelength of 365 nm, ultraviolet rays having an irradiance of 75 mW/cm² at wavelengths of 320 nm to 450 nm were radiated for 30 seconds to yield an adhesive sheet having a polymerization rate of 72% (the total of the ultraviolet ray radiating periods in the first and second radiating substeps was unchanged to be 50 seconds).

### Example 4

### Preparation of Ultraviolet-Ray Curing-Type Acrylic Pressure-Sensitive Adhesive Composition

To 100 parts by weight of the acrylic polymer syrup 2 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 99% was produced in the same way as in Example 1 except that: the adhesive composition described just above was used; from the ultraviolet lamp in the first radiating substep, which was an LED lamp (manufactured by Hamamatsu Photonics K.K.) having a peak wavelength of 365 nm, ultraviolet rays having an irradiance of 75 mW/cm² at wavelengths of 320 nm to 450 nm were radiated for 32 seconds to yield an adhesive sheet having a polymerization rate of 64%, and the total of the ultraviolet ray radiating periods in the first and second radiating substeps was changed to 80 seconds.

### Example 5

### Preparation of Ultraviolet-Ray Curing-Type Acrylic Pressure-Sensitive Adhesive Composition

To 100 parts by weight of the acrylic polymer syrup 4 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 99% was produced in the same way as in Example 1 except that: the adhesive composition described just above was used; from the ultraviolet lamp in the first radiating substep, which was an LED lamp (manufactured by Hamamatsu Photonics K.K.) having a peak wavelength of 365 nm, ultraviolet rays having an irradiance of 75 mW/cm² at wavelengths of 320 nm to 450 nm were radiated for 48 seconds to yield an adhesive sheet having a polymerization rate of 89%; and the total of the ultraviolet ray radiating periods in the first and second radiating substeps was changed to 80 seconds.

### Example 6

### Preparation of Ultraviolet-Ray Curing-Type Acrylic Pressure-Sensitive Adhesive Composition

To 100 parts by weight of the acrylic polymer syrup 1 were added 0.05 parts by weight of a photopolymerization initiator “Irgacure 184” and 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 99% was produced using the adhesive composition described just above in the same way as in Example 1 except that: from the ultraviolet lamp in the first radiating substep, which was an LED lamp (manufactured by Hamamatsu Photonics K.K.) having a peak wavelength of 365 nm, ultraviolet rays having an irradiance of 75 mW/cm² at wavelengths of 320 nm to 450 nm were radiated for 30 seconds to yield an adhesive sheet having a polymerization rate of 87%; next, the LED lamp in the second radiating substep, which was a metal halide lamp (manufactured by Harison Toshiba Lighting Corp.) having a peak wavelength of 365 nm, was used to radiate, onto the adhesive sheet, ultraviolet rays having an irradiance of 300 mW/cm² having at wavelengths of 320 nm to 450 nm for 10 seconds while the adhesive sheet was being transported; and the total of the ultraviolet ray radiating periods in the first and second radiating substeps was changed to 40 seconds.

### Comparative Example 1

### Preparation of Ultraviolet-Ray Curing-Type Acrylic Pressure-Sensitive Adhesive Composition

To 100 parts by weight of the acrylic polymer syrup 3 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 99% was produced in the same way as in Example 1 except that: the adhesive composition described just above was used; the ultraviolet lamp in the first radiating substep was changed to an LED lamp (manufactured by Hamamatsu Photonics K.K.) having a peak wavelength of 385 nm, and ultraviolet rays having an irradiance of 35 mW/cm² at wavelengths of 320 nm to 450 nm were radiated therefrom for 24 seconds to yield an adhesive sheet having a polymerization rate of 46%; and the total of the ultraviolet ray radiating periods in the first and second radiating substeps was changed to 80 seconds.

### Comparative Example 2

### Preparation of Ultraviolet-Ray Curing-Type Acrylic Pressure-Sensitive Adhesive Composition

To 100 parts by weight of the acrylic polymer syrup 4 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 99% was produced in the same way as in Example 1 except that: the adhesive composition described just above was used; from the ultraviolet lamp in the first radiating substep, which was an LED lamp (manufactured by Hamamatsu Photonics K.K.) having a peak wavelength of 365 nm, ultraviolet rays having an irradiance of 75 mW/cm² at wavelengths of 320 nm to 450 nm were radiated for 24 seconds to yield an adhesive sheet having a polymerization rate of 20%; and the total of the ultraviolet ray radiating periods in the first and second radiating substeps was changed to 80 seconds.

### Comparative Example 3

### Preparation of Ultraviolet-Ray Curing-Type Acrylic Pressure-Sensitive Adhesive Composition

To 100 parts by weight of the acrylic polymer syrup 2 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 98% was produced in the same way as in Example 1 except that: the adhesive composition described just above was used; from the ultraviolet lamp in the first radiating substep, which was an LED lamp (manufactured by Hamamatsu Photonics K.K.) having a peak wavelength of 365 nm, ultraviolet rays having an irradiance of 75 mW/cm² at wavelengths of 320 nm to 450 nm were radiated for 24 seconds to yield an adhesive sheet having a polymerization rate of 83%; and the total of the ultraviolet ray radiating periods in the first and second radiating substeps was changed to 80 seconds.

### Comparative Example 4

### Preparation of Ultraviolet-Ray Curing-Type Acrylic Pressure-Sensitive Adhesive Composition

To 100 parts by weight of the acrylic polymer syrup 2 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 85% was produced in the same way as in Example 1 except that: the adhesive composition described just above was used; and the ultraviolet lamp in the first radiating substep was changed to an LED lamp (manufactured by Nitride Semiconductors Co., Ltd.) having a peak wavelength of 375 nm, and ultraviolet rays having an irradiance of 14 mW/cm² at wavelengths of 320 nm to 450 nm were radiated therefrom for 180 seconds without performing the second radiating substep. Thus, the total ultraviolet ray radiating period was 180 seconds, and the above-mentioned adhesive sheet (polymerization rate: 85%) was a finally-obtained adhesive sheet.

### Comparative Example 5

### Preparation of Ultraviolet-Ray Curing-Type Acrylic Pressure-Sensitive Adhesive Composition

To 100 parts by weight of the acrylic polymer syrup 2 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 8% was produced in the same way as in Example 1 except that: the adhesive composition described just above was used; and the ultraviolet lamp in the first radiating substep was changed to an LED lamp (manufactured by Nitto Denko Corp.) having a peak wavelength of 470 nm, and ultraviolet rays having an irradiance of 40 mW/cm² at wavelengths of 450 nm or more were radiated therefrom for 300 seconds without performing the second radiating substep. Thus, the total ultraviolet ray radiating period was 300 seconds, and the above-mentioned adhesive sheet (polymerization rate: 8%) was a finally-obtained adhesive sheet.

### Comparative Example 6

### Preparation of Ultraviolet-Ray Curing-Type Acrylic Pressure-Sensitive Adhesive Composition

To 100 parts by weight of the acrylic polymer syrup 2 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 98% was produced in the same way as in Example 1 except that: the adhesive composition described just above was used; and the ultraviolet lamp in the first radiating substep was changed to a black light lamp (manufactured by Harison Toshiba Lighting Corp.) having a peak wavelength of 356 nm, and ultraviolet rays having an irradiance of 6 mW/cm² at wavelengths of 320 nm to 450 nm were radiated therefrom for 180 seconds without performing the second radiating substep. Thus, the total ultraviolet ray radiating period was 180 seconds, and the above-mentioned adhesive sheet (polymerization rate: 98%) was a finally-obtained adhesive sheet.

### Comparative Example 7

### Preparation of Ultraviolet-Ray Curing-Type Acrylic Pressure-Sensitive Adhesive Composition

To 100 parts by weight of the acrylic polymer syrup 2 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

A pressure-sensitive adhesive sheet having a polymerization rate of 90% was produced in the same way as in Example 1 except that: the adhesive composition described just above was used; the ultraviolet lamp in the first radiating substep was changed to a black light lamp (manufactured by Harison Toshiba Lighting Corp.) having a peak wavelength of 356 nm, and ultraviolet rays having an irradiance of 6 mW/cm² at wavelengths of 320 nm to 450 nm were radiated therefrom for 60 seconds to yield an adhesive sheet having a polymerization rate of 60%; and the total of the ultraviolet ray radiating periods in the first and second radiating substeps was changed to 80 seconds.

The pressure-sensitive adhesive sheets were each evaluated by the following methods:

### Polymerization Rate:

The weight (X₁g) of a sample from the sheet which was to be measured about the polymerization rate thereof was measured, and the sample was dried at 130° C. for 2 hours. The weight (X₂g) of the sample was again measured. From the weights X₁g and X₂g, the polymerization rate was calculated in accordance with “polymerization rate (%)=(X₂/X₁)×100”.

### Heat-Resistant Holding Power:

One of releasing-liners (polyester films) of the pressure-sensitive adhesive sheet was peeled off, and the adhesive sheet was bonded to a polyethylene terephthalate film of 50 μm thickness. The resultant was cut into a width of 10 mm to form a sample tape. A releasing-liner was peeled off from the other adhesive surface of the sample tape. The sample tape was bonded onto a bakelite plate as an adherend to have a bonded area of 10 mm width and 29 mm length by reciprocating a 2 kg roller onetime onto the plate. This was allowed to stand still in an environment of 80° C. temperature for 30 minutes, and then the bakelite plate was vertically hung to give a load of 500 g to a free end of the sample piece. The sample was allowed to standstill in an environment of 80° C. temperature for 2 hours in the state that the load was given. When the sample dropped in a 2 hours or less, the time up to the dropping was measured. When the sample adhered onto the adherend without dropping after the 2 hours, the length (mm) of the shift of the sample from the initially sample-adhering position was measured. When the shift length of the sample tape was less than 2.0 mm in this case the sample tape was judged to be good (circular sign). When the sample tape gave a shift length of 2.0 mm or more, or dropped, the sample tape was judged to be bad (cross sign).

Results of this evaluation are shown in Table 1. In Comparative Examples 4, 5 and 7, the content by percentage of their monomer-component matter was 10% or more. Thus, no pressure-sensitive adhesive sheet was unable to be formed, so that no heat-resistant holding power was measured.

TABLE 1

| | | | First radiating substep | | | | | Second radiating substep | | | | | Total | |
|---|---|---|---|---|---|---|---|---|---|---|---|---|---|---|
| | | | | | | Ultra- | | | | | Ultra- | | ultra- | |
| | | | | Peak | | violet | | | Peak | | violet | | violet | Heat- |
| | | | | wave- | | ray | | | wave- | | ray | | ray | resistant |
| | Photopoly- | | | length | | radi- | | | length | | radi- | Final | radi- | holding |
| | merization | | Ultra- | (nm) of | Irra- | ating | | Ultra- | (nm) of | Irra- | ating | polymer- | ating | force |
| | initiator | | violet | ultra- | diance | period | Polymer- | violet | ultra- | diance | period | ization | period | shift- |
| | First | Second | lamp | violet | (mW/ | (sec- | ization | lamp | violet | (mW/ | (sec- | rate | (sec- | length |
| | species | species | species | lamp | cm²) | onds) | rate (%) | species | lamp | cm²) | onds) | (%) | onds) | (mm) |
| Example 1 | Irgacure | Irgacure | LED | 365 | 75 | 30 | 87 | Metal | 365 | 75 | 20 | 99 | 50 | 0.5 |
| | 819 | 184 | | | | | | halide | | | | | | (good) |
| Example 2 | Irgacure | Irgacure | LED | 385 | 40 | 30 | 81 | Metal | 365 | 75 | 20 | 99 | 50 | 0.5 |
| | 819 | 184 | | | | | | halide | | | | | | (good) |
| Example 3 | Irgacure | Irgacure | LED | 365 | 75 | 30 | 72 | Metal | 365 | 75 | 20 | 99 | 50 | 0.8 |
| | 819 | 127 | | | | | | halide | | | | | | (good) |
| Example 4 | Irgacure | Irgacure | LED | 365 | 75 | 32 | 64 | Metal | 365 | 75 | 48 | 99 | 80 | 0.5 |
| | 651 | 184 | | | | | | halide | | | | | | (good) |
| Example 5 | Irgacure 184 | | LED | 365 | 75 | 48 | 89 | Metal | 365 | 75 | 32 | 99 | 80 | 0.2 |
| | | | | | | | | halide | | | | | | (good) |
| Example 6 | Irgacure | Irgacure | LED | 365 | 75 | 30 | 87 | Metal | 365 | 300 | 10 | 99 | 40 | 0.5 |
| | 819 | 184 | | | | | | halide | | | | | | (good) |
| Compar- | Irgacure 651 | | LED | 385 | 35 | 24 | 46 | Metal | 365 | 75 | 56 | 99 | 80 | 3.4 |
| ative | | | | | | | | halide | | | | | | (bad) |
| Example 1 | | | | | | | | | | | | | | |
| Compar- | Irgacure 184 | | LED | 365 | 75 | 24 | 20 | Metal | 365 | 75 | 56 | 99 | 80 | Dropped |
| ative | | | | | | | | halide | | | | | | in 84 |
| Example 2 | | | | | | | | | | | | | | minutes |
| | | | | | | | | | | | | | | (bad) |
| Compar- | Irgacure | Irgacure | High- | 365 | 75 | 24 | 83 | Metal | 365 | 75 | 56 | 98 | 80 | 3.1 |
| ative | 651 | 184 | pressure | | | | | halide | | | | | | (bad) |
| Example 3 | | | mercury | | | | | | | | | | | |
| Compar- | Irgacure | Irgacure | LED | 375 | 14 | 180 | 85 | Non second radiating step | | | | 85 | 180 | Unmeas- |
| ative | 651 | 184 | | | | | | | | | | | | urable |
| Example 4 | | | | | | | | | | | | | | |
| Compar- | Irgacure | Irgacure | LED | 470 | 40 | 300 | 8 | Non second radiating step | | | | 8 | 300 | Unmeas- |
| ative | 651 | 184 | | | | | | | | | | | | urable |
| Example 5 | | | | | | | | | | | | | | |
| Compar- | Irgacure | Irgacure | Black | 356 | 6 | 180 | 98 | Non second radiating step | | | | 98 | 180 | 0.1 |
| ative | 651 | 184 | light | | | | | | | | | | | (good) |
| Example 6 | | | | | | | | | | | | | | |
| Compar- | Irgacure | Irgacure | Black | 356 | 6 | 60 | 60 | Metal | 365 | 75 | 20 | 90 | 80 | Unmeas- |
| ative | 651 | 184 | light | | | | | halide | | | | | | urable |
| Example 7 | | | | | | | | | | | | | | |

From Table 1, it is understood that the present examples can each produce, in a total ultraviolet ray radiating period of 80 seconds or less, a pressure-sensitive adhesive sheet having a final polymerization rate of 97% or more to be excellent in productivity, and having an excellent holding power at high temperature.

1. A method for producing a pressure-sensitive adhesive sheet, the method comprising:
an applying step in which an ultraviolet-ray curing-type acrylic pressure-sensitive adhesive composition containing at least a monomer-component matter that is/contains an alkyl (meth)acrylate, and/or a partial polymer made from the monomer-component matter, and a photopolymerization initiator, is applied onto a substrate;
an pressure-sensitive adhesive layer forming step in which the pressure-sensitive adhesive composition is irradiated with and cured by ultraviolet light to form a pressure-sensitive adhesive layer;
wherein the pressure-sensitive adhesive layer forming step has
a first radiating substep of using, as an ultraviolet source, an LED lamp having a peak wavelength in the range of 300 nm to 450 nm to expose the pressure-sensitive adhesive composition to light from the LED lamp; and
a second radiating substep of using, as an ultraviolet source, an ultraviolet lamp for emitting light having a peak wavelength in the range from 300 nm to 450 nm and further including a wavelength in the range of 100 nm or more and less than 300 nm after the first radiating substep to expose the pressure-sensitive adhesive composition to the light; and
wherein, at a time when the first radiating substep has ended, a polymerization rate of the pressure-sensitive adhesive composition is 50% or more.

2. The method for producing a pressure-sensitive adhesive sheet according to claim 1, wherein an irradiance of the ultraviolet rays in each of the first and second radiating substeps is 20 mW/cm² or more.

3. The method for producing a pressure-sensitive adhesive sheet according to claim 1, wherein the photopolymerization initiator contains at least
a first photopolymerization initiator species having an absorption coefficient of 1×10² mLg⁻¹ cm⁻¹ or more at 405 nm, and an absorption coefficient of 1×10² mLg⁻¹ cm⁻¹ or more at 302 nm, and
a second photopolymerization initiator species having an absorption coefficient of less than 1×10² mLg⁻¹ cm⁻¹ at 405 nm, and an absorption coefficient of 1×10² mLg⁻¹ cm⁻¹ or more at 302 nm;
wherein content of the first photopolymerization initiator species in the pressure-sensitive adhesive composition is from 0.01 parts by weight to 5 parts by weight for 100 parts by weight of the monomer-component matter, which is/contains the alkyl (meth)acrylate, and/or the partial polymer made from the monomer-component matter; and
wherein content of the second photopolymerization initiator species in the pressure-sensitive adhesive composition is from 0.01 parts by weight to 5 parts by weight for 100 parts by weight of the monomer-component matter, which is/contains the alkyl (meth)acrylate, and/or the partial polymer made from the monomer-component matter.

4. The method for producing a pressure-sensitive adhesive sheet according to claim 2, wherein the photopolymerization initiator contains at least
a first photopolymerization initiator species having an absorption coefficient of 1×10² mLg⁻¹ cm⁻¹ or more at 405 nm, and an absorption coefficient of 1×10² mLg⁻¹ cm⁻¹ or more at 302 nm, and
a second photopolymerization initiator species having an absorption coefficient of less than 1×10² mLg⁻¹ cm⁻¹ at 405 nm, and an absorption coefficient of 1×10² mLg⁻¹ cm⁻¹ or more at 302 nm;
wherein content of the first photopolymerization initiator species in the pressure-sensitive adhesive composition is from 0.01 parts by weight to 5 parts by weight for 100 parts by weight of the monomer-component matter, which is/contains the alkyl (meth)acrylate, and/or the partial polymer made from the monomer-component matter; and
wherein content of the second photopolymerization initiator species in the pressure-sensitive adhesive composition is from 0.01 parts by weight to 5 parts by weight for 100 parts by weight of the monomer-component matter, which is/contains the alkyl (meth)acrylate, and/or the partial polymer made from the monomer-component matter.

5. The method for producing a pressure-sensitive adhesive sheet according to claim 1, wherein the monomer-component matter comprises a polyfunctional monomer.

6. The method for producing a pressure-sensitive adhesive sheet according to claim 2, wherein the monomer-component matter comprises a polyfunctional monomer.

7. The method for producing a pressure-sensitive adhesive sheet according to claim 3, wherein the monomer-component matter comprises a polyfunctional monomer.

8. The method for producing a pressure-sensitive adhesive sheet according to claim 4, wherein the monomer-component matter comprises a polyfunctional monomer.
